(19) United States
(12) Patent Application Publication
(10) Pub. No.: US 2019/0014063 A1
(43) Pub. Date: Jan. 10, 2019

(54) System and Methods for Dynamically Generating Animated GIF Files for Delivery Via the Network

(71) Applicant: ANIVIEW LTD., Tel Aviv (IL)

(72) Inventors: Tal Melenboim, Ashdod (IL); Itay Nave, Herzliya (IL); Mark Rean, Herzliya (IL)

(21) Appl. No.: 15/037,626

(22) PCT Filed: May 9, 2016
(86) PCT No.: PCT/IB2016/052635

§ 371 Date: May 18, 2016

Related U.S. Application Data
(60) Provisional application No. 62/313,750, filed on Mar. 27, 2016.

(51) Int. Cl. H04L 12/58; G06Q 30/02; H04N 21/81

(52) U.S. Cl. CPC H04L 51/10; H04L 51/08; G06T 13/80; H04N 21/812; H04N 21/816; G06Q 30/0277

(57) ABSTRACT

A system enables delivery of video clips as animated gif files embedded in e-mail messages sent over a network. The system receives a request to send a video clip via an e-mail. The system fetches the video clip and metadata associated therewith. The system decodes the video clip to a plurality of images. Then, respective of the plurality of images, the system generates an animated gif file. The system further generates an overlay respective of the metadata and adds the overlay to the animated gif file. The system then provides the overlaid animated gif file to, for example, a user device via the network.

This application claims the benefit of U.S. Provisional Application No. 62/313,750, filed on 27 Mar. 2016, the contents of which are herein incorporated by reference for all that it contains.

### TECHNICAL FIELD

The disclosure generally relates to systems for sending video content via email, and more specifically to system and methods for dynamically generating animated files for sending via emails.

### DESCRIPTION OF THE BACKGROUND

The Internet, also referred to as the worldwide web (WWW), has become a mass media where the content presentation is largely spread out and the sending of video files via the network is a commodity.

As such, marketing professionals have come to recognize that still images now lack the allure they might once have had, compared to the allure of a video clip. Static billboards and displays are continually being replaced by video display devices; airport terminal passageways, for example, are typically lined with one video screen after another, each displaying a video intended to attract the attention of the passers-by. In like manner, the number of commercial web-sites having windows presenting video advertisements is also increasing.

The use of video in e-mail marketing, however, is significantly lagging behind the use of video in other marketing arenas. A common method for transmitting video content via e-mail is to attach the video file to an e-mail message.

Among friends and colleagues, this is a fairly effective technique, because the recipient of the e-mail is likely to have an interest in viewing the attached file, and will perform the necessary actions to launch a viewer that renders the content of the file. Among advertisers and potential customers, such an interest would be rare, and most of the recipients of an advertisement video are not likely to purposely initiate a playback of the advertisement.

It would therefore be advantageous to provide a solution that would overcome the deficiencies of the prior art by providing a method by which video content items can be sent by users simply and without an undue burden.

### SUMMARY

As additional description to the embodiments described below, the present disclosure describes the following embodiments.

Embodiment 1 is a computerized method for dynamically generating animated gif files for delivery via a network, the method comprising: receiving a request from a first user device to send at least one video content item via a delivery system to at least one source over the network; fetching the at least one video content item and metadata respective thereof; generating an animated gif file respective of the at least one video content item; generating an overlay to the animated gif file respective of the metadata; and, sending the animated gif file together with the overlay to the at least one source.

Embodiment 2 is the computerized method of embodiment 1, wherein the overlay comprises a responsive link to the at least one video content item.

Embodiment 3 is the computerized method of embodiment 1, wherein the user device is one of a group consisting of a smart phone, a mobile phone, a tablet computer, a wearable computing device, a personal computer, and a smart television.

Embodiment 4 is the computerized method of embodiment 1, wherein the generation of the animated gif file further comprises: selecting at least one codec respective of the metadata; configuring the at least one codec to decode the at least one video content item to a set of frames; and, generating the animated gif file respective of the set of frames.

Embodiment 5 is the computerized method of embodiment 1, wherein the delivery system is an e-mail system.

Embodiment 6 is the computerized method of embodiment 1, wherein (i) receiving the request, (ii) fetching the at least one video content item and metadata respective thereof, (iii) generating the animated gif file, (iv) generating the overlay, and (v) sending the animated gif file together with the overlay is performed by a computing system in response to a single user input gesture performed at the first user device without additional user input at the first user device.

Embodiment 7 is the computerized method of embodiment 1, wherein the metadata includes at least one of a group consisting of a type of the at least one video content item, a length of the at least one video content item, a resolution of the at least one video content item, container data, video data, audio data, and textual data.

Embodiment 8 is a non-transitory computer readable medium having stored thereon instructions for causing one or more processing units to execute operations comprising: receiving a request from a first user device to send at least one video content item via a delivery system to at least one source over the network; fetching the at least one video content item and metadata respective thereof; generating an animated gif file respective of the at least one video content item; generating an overlay to the animated gif file respective of the metadata; and, sending the animated gif file together with the overlay to the at least one source.

Embodiment 9 is a system for dynamically generating animated gif files for delivery via a network, the system comprises: an interface to receive a request from a first user device to send at least one video content item via a delivery system to at least one source over the network; a plurality of codecs; a processing unit connected to the interface; memory connected to the processing unit, the memory containing instructions therein that when executed by the processing unit configure the system to:
fetch the at least one video content item and metadata respective thereof; generate an animated gif file respective of the at least one video content item; generate an overlay to the animated gif file respective of the metadata; and, send the animated gif file together with the overlay to the at least one source.

Embodiment 10 is the system of embodiment 8, wherein the user device is one of a group consisting of a smart phone, a mobile phone, a tablet computer, a wearable computing device, a personal computer (PC), and a smart television.

Embodiment 11 is the system of embodiment 8, wherein the overlay comprises a responsive link to the at least one video content item.

Embodiment 12 is the system of embodiment 8, wherein the generation of the animated gif file further comprises: selecting at least one codec respective of the metadata; configuring the at least one codec to decode the at least one video content item to a set of frames; and, generating the animated gif file respective of the set of frames.

Embodiment 13 is the system of embodiment 8, wherein the delivery system is an e-mail system.

Embodiment 14 is the system of embodiment 9, wherein (i) receiving the request, (ii) fetching the at least one video content item and metadata respective thereof, (iii) generating the animated gif file, (iv) generating the overlay, and (v) sending the animated gif file together with the overlay is performed by a computing system in response to a single user input gesture performed at the first user device without additional user input at the first user device.

Embodiment 15 is the system of embodiment 8, wherein the metadata includes at least one of a group consisting of a type of the at least one video content item, a length of the at least one video content item, a resolution of the at least one video content item, container data, video data, audio data, and textual data.

Embodiment 16 is the system of embodiment 8, wherein the at least one source is a second user device.

Embodiment 17 is a computerized method for dynamically providing animated gif files as video advertisements, the method comprising: receiving a request for content that exists in a web source from a user device over a network; generating metadata respective of the request; selecting at least one video advertisement respective of the metadata; generating an animated gif file respective of each of the at least one selected video advertisement; and, sending the animated gif file to the user device.

Embodiment 18 is the computerized method of embodiment 15, further comprising: generating an overlay to the animated gif file respective of the metadata; and, adding the overlay to the animated gif file.

Embodiment 19 is the computerized method of embodiment 16, wherein the overlay comprises a responsive link to the at least one video content item.

Embodiment 20 is the computerized method of embodiment 15, wherein the user device is one a group consisting of a smart phone, a mobile phone, a tablet computer, a wearable computing device, a personal computer, and a smart television.

Embodiment 21 is the computerized method of embodiment 15, wherein the generation of the animated gif file further comprises: selecting at least one codec respective of the metadata; configuring the at least one codec to decode the at least one video content item to a set of frames; and, generating an animated gif file respective of the set of frames.

Embodiment 22 is the wherein the metadata comprises at least one of the group consisting of: a type of the video content item, a type of request, and a type of user device.

Embodiment 23 is a non-transitory computer readable medium having stored thereon instructions for causing one or more processing units to execute operations comprising: receiving a request for content exist in a web source from a user device over a network; generating metadata respective of the request; selecting at least one video-ad respective of the metadata; generating an animated gif file respective of each of the at least one selected video-ad; and, sending the animated gif file to the user device.

### BRIEF DESCRIPTION OF THE DRAWINGS

The subject matter that is regarded as the disclosure is particularly pointed out and distinctly claimed in the claims at the conclusion of the specification. The foregoing and other objects, features and advantages of the disclosure will be apparent from the following detailed description taken in conjunction with the accompanying drawings.

FIG. 1—is a system for enabling delivery of video clips embedded in e-mails according to an embodiment.

FIG. 2—is a flowchart describing the operation of a method for enabling delivery of video clips embedded in e-mails according to an embodiment.

FIG. 3—is a flowchart describing the operation of a method for generating animated gif files respective of video content items according to an embodiment.

FIG. 4—is a schematic diagram of an agent installed on the user device for enabling delivery of video clips embedded in e-mails according to an embodiment.

FIG. 5—depicts an exemplary and non-limiting flowchart describing an operation of a video-ad system according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

A system enables delivery of video clips as animated gif files embedded in e-mail messages sent over a network. The system receives a request to send a video clip via an e-mail. The system fetches the video clip and metadata associated therewith. The system decodes the video clip to a plurality of images. Then, respective of the plurality of images, the system generates an animated gif file. The system further generates an overlay respective of the metadata and adds the overlay to the animated gif file. The system then provides the overlaid animated gif file to, for example, a user device via the network.

In order to embed video content in an e-mail message, the video content is fetched and animated gif files are generated from the video. To do so, the video content item is decoded in real time, responsive to the request. This process is executed with a codec. The current disclosure discloses decoding of the video content and generating an animated gif file from the video.

The animated gif file comprises an overlay. According to an embodiment, the overlay comprises a responsive link to the video content. Once a user's gesture is received, the link directs the user to a web source comprising the video clip as further described herein below. As a non-limiting example, responsive to a mouse click over the animated gif, an advertisement video is automatic played on a web browser of the user device 120. According to this example, the user device 120 received via a user device an email comprising the animated gif. The animated gif automatically begins animating in response to display of the email by the user device 120. Upon receipt of user input that clicks on the animated gif, the user device 120 launches (e.g., executes) a web browser that automatically plays the video. The web browser may automatically play the video by navigating to a web address that is specified by an overlay of the animated gif.

Graphics interchange format (gif) is a bitmap image format that was introduced by CompuServe in 1987. The format supports up to 8 bits per pixel for each image, allowing a single image to reference its own palette of up to 256 different colors chosen from the 24-bit RGB color space. It also supports animations and allows a separate palette of up to 256 colors for each frame.

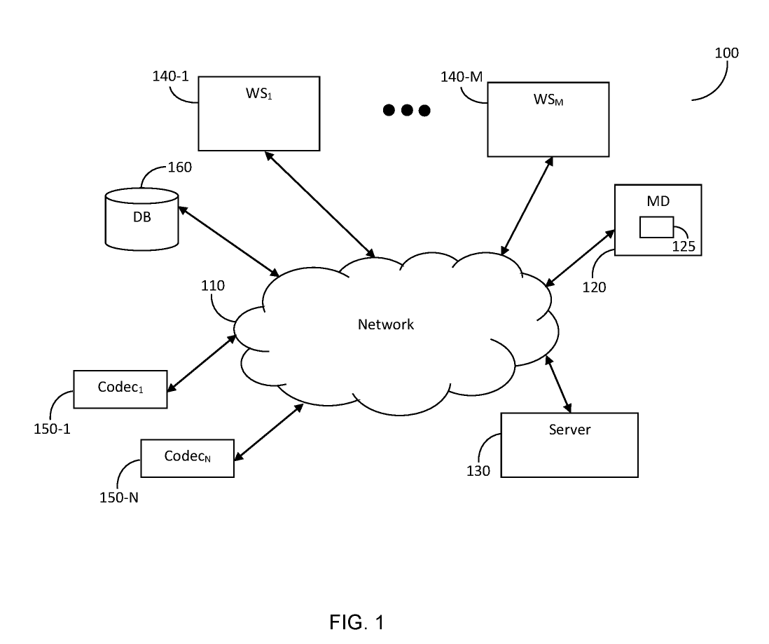

FIG. 1 depicts an exemplary and non-limiting diagram of a system 100 for enabling the sending of video content according to an embodiment. The system 100 comprises a network 110 that enables communications between various portions of the system 100. The network 110 may comprise the likes of busses, a local area network (LAN), a wide area network (WAN), a metro area network (MAN), the worldwide web (WWW), the Internet, as well as a variety of other communication networks, whether wired or wireless, and in any combination, that enable the transfer of data between the different elements of the system 100.

The system 100 further comprises a user device 120 connected to the network 110. The user device 120 may be, for example but without limitations, a smart phone, a mobile phone, a tablet computer, a wearable computing device, a personal computer (PC), a smart television and the like. The user device 120 comprises an agent 125 installed therein. The agent 125 may be a dedicated application, script, or any program code stored in a memory of the user device 120 and may be executable, for example, by the operating system of the user device 120. The agent 125 may be configured to perform some or all of the processes performed by a server 130 which is further connected to the network 110 and disclosed herein.

The system 100 further comprises one or more web sources 140-1 through 140-M (collectively referred hereinafter as web sources 140 or individually as a web source 140, merely for simplicity purposes), where M is an integer equal to or greater than 1. The web sources 140 may be web pages, websites, etc., accessible through the network 110. The web sources 140 may be operated by one or more publisher servers (not shown).

The server 130 is configured to receive a request to send at least one video content element from the user device 120 over the network 110. For example, a user may compose an email using an email application on the user device 120. According to another embodiment, the composition of the email may be made via another interface which is not a standard email application, e.g, a designated interface which enables the user to draft a structured email together with an animated gif as further described herein below. As part of drafting this email the user can indicate that a video file should be embedded in the email as an animated gif. For example, the user can click on a button in the email application. In response, the email application can launch a dialog box to select a file. Then the user can select a file (e.g., a video file) with the file selector (e.g., stored on the user device 120 or at an internet address). In another example, the user can drag-and-drop a video file into the user interface of the email application. With the video file selected, the user device 120 can send the request to the server 130. According to one embodiment, the request may be generated in response to a user's gesture over the display unit 125 of the user device 120. The user gesture may be, for example, clicking a ‘send’ email button. After the user has clicked the ‘send’ email button, the request to send the at least one video content element may be generated and sent, along with the email, without additional user input. That is, the user may select the video for embedding, thereafter click a ‘send’ email button, and the user device 120 may send the request to send at least one video content element, as part of sending the email. In standard delivery systems scripts cannot be embedded to an outgoing message.

Respective of the request, the server 130 is configured to fetch the at least one video content item from a web source, for example the web source 140-1. According to an embodiment, the server 130 is further configured to identify metadata associated with the at least one video content item. The metadata may include, for example, a type of the at least one video content item, a length of the at least one video content item, a resolution of the at least one video content item, container data, video data, audio data, textual data, and more. Container data may include, for example, a format, profile, commercial name of the format, duration, overall bit rate, writing application and library, title, author, director, album, track number, etc. The type of the at least one video content item may be the file format, e.g, MP4, MOV, MPEG, M4V, etc. Video data may include, for example, video format, codec identification data, aspect, frame rate, bit rate, color space, bit depth, scan type, scan order, etc. Audio date may include, for example, audio format, audio codec identification data, sample rate, channels, language, data bit rate, etc. Textual data may include, for example, textual format data, textual codec identification data, language of subtitle, etc.

The server 130 is then configured to select at least one codec of a plurality of codecs 150-1 through 150-N (collectively referred hereinafter as codecs 150 or individually as a codec 150, merely for simplicity purposes), where N is an integer equal to or greater than 1. The codec 150 is an electronic circuit or software that enables manipulation of video content such as, for example, compression and/or decompression of video content, conversion of video content to different file types, encoding and/or decoding of video content, etc. Different types of video content items require different codecs and therefore the selection of the appropriate codec is required in order to generate display video content on a variety of operation systems of user devices. Furthermore, the operation of the system 100 enables auto-play of the video content as the frames of the original video content are consequently displayed on the user device 120 as further described herein below.

Following the selection of the at least one codec, for example, the codec 150-1, the server 130 initializes the codec 150-1 to decode the video content item. The codec then generates an animated gif respective of the at least one video content item. According to an embodiment, the codec 150-1 may process the at least one video content item by one or more computational cores that constitute an architecture for generating the set of frames respective thereof.

The server 130 then generates an overlay over the animated video content item respective of the metadata. The overlay may be a transparent or non-transparent user interface element that is capable of receiving user input and/or displaying information. The overlay may be responsive to a user's input such as a gesture input. According to an embodiment, the overlay may include a link to the at least one video content item in the web source 140-1. According to further embodiment, the overlay may include one or more features such as, for example, time bar, textual bar, etc.

The server 130 then provides the overlaid animated gif to the user device 120. According to an embodiment, the system 100 further comprises a database 160 communicatively coupled to the server 130 over the network 110. According to another embodiment, together with the request, the server 130 may receive from the user device 120, a target user device, for example, the user device 120-2 to send the at least one video content item to. Responsive thereto, the overlaid animated gif file shall be sent by the server 130 to the user device 120-2. For example, the server can respond with an HTML formatted response that includes the gif image and an overlay. The response can be embedded into the HTML formatted email in real time.

According to another embodiment, the system 100 may be used for providing video advertisements (video-ads) to the user device 120 as animated gif files. According to this embodiment, the operation of the system 100 starts when the user device 120 sends a request for a certain content that exists in a web source of the web sources 140, for example the web source 140-1, via the network 110. The request for content triggers the server 130 to select at least one video-ad to provide to the user device 120 responsive to the request for content. The video-ad may be selected by the server 130 out of a plurality of video-ads that exist in, for example, a publisher server. According to an embodiment, the selection may be made respective of the metadata associated with the user device 120, the content and/or the request. The server 130 then generates an animated gif respective of the video-ad and provides the animated gif to the user device.

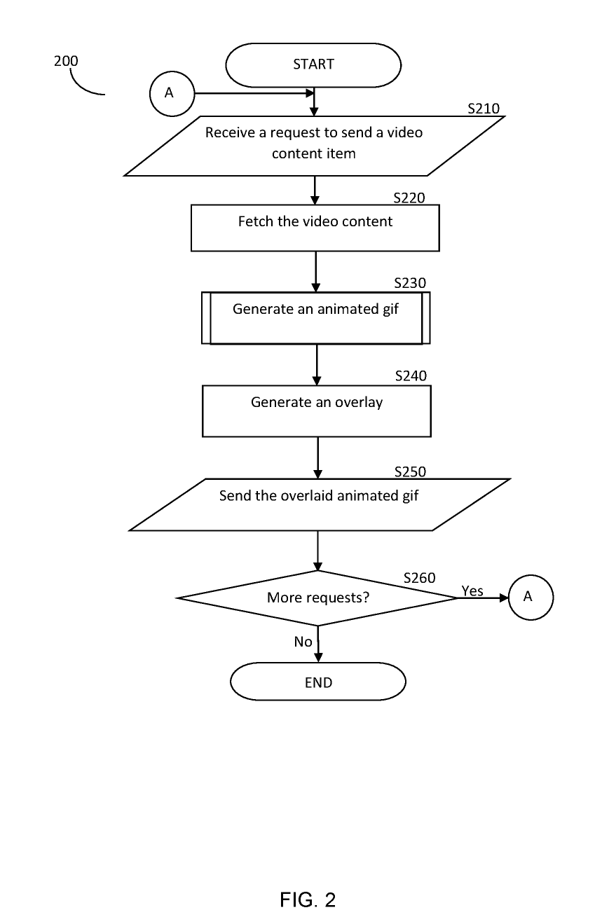

FIG. 2 is an exemplary and non-limiting flowchart 200 of the operation of a method for displaying an auto-played video content on a display of a user device according to an embodiment. In S210, the operation starts when a request to send at least one video content item from a first user device to a second user device is received. For example the request may specify sending the video content item from the user device 120-1 to the user device 120-2. According to an embodiment, the request may be to embed the at least one video content item in an e-mail message. User interface elements to insert a gif in an email may be presented to the user in the same or similar fashion to how other file types are embedded or attached to email messages. For example, a plug-in button may be pressed. The user device 120-1 can request that the user select a video file, and then the display can update to show that the user the video file will be embedded as an animated gif having a link to the original video. After the user has supplied the selected video file and pressed a ‘send’ button, the user device 120-1 may perform the operations needed to request the conversion and send the email without additional user input.

In some examples, the user device 120-1 requests the gif file in response to the user pressing the ‘send’ button, and sends the email only after the user device 120-1 receives the gif and inserts the gif into the email. In other examples, the user device 120-1 sends the email in response to the user pressing the ‘send’ button (without the email including the gif), and a remote computing system modifies the email to include the gif file before the email is delivered to the recipient device. In this example, the email may include code that identifies the video and that prompts the remote computing system to (i) send a request to covert the video into the gif, and (ii) insert the gif into the email.

In S220, the at least one video content item is fetched by the server 130 from a web source, for example, the web source 140-1. S220 may further include identifying metadata associated with the at least one video content item from the web source 140-1.

The metadata may include, for example, a type of the at least one video content item, length of the at least one video content item, resolution of the at least one video content item, container data, video data, audio data, textual data and more. Container data may include, for example, a format, profile, commercial name of the format, duration, overall bit rate, writing application and library, title, author, director, album, track number, etc. The type of the at least one video content item may be the file format e.g, MP4, MOV, MPEG, M4V, etc. Video data may include, for example, video format, codec identification data, aspect, frame rate, bit rate, color space, bit depth, scan type, scan order, etc. Audio date may include, for example, audio format, audio codec identification data, sample rate, channels, language, data bit rate, etc. Textual data may include, for example, textual format data, textual codec identification data, language of subtitle, etc.

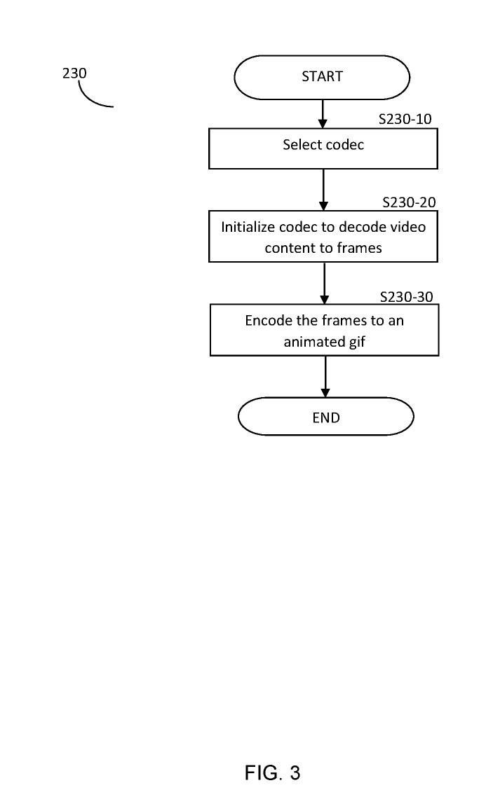

In S230, respective of the at least one video content item and the respective metadata, an animated gif file is generated. An exemplary embodiment of the animated gif file is further described herein below with respect of FIG. 3.

In S240, an overlay is generated for the animated gif file. According to an embodiment, the overlay is generated respective of the metadata. The overlay may include one or more features associated with the animated gif file. The features may be, for example, a time bar, a textual bar, content related to the animated gif file and/or the at least one video content item. The feature(s) may include a link to the web source 140-1 or other content over the network associated therewith.

In S250, the overlaid animated gif file is provided to, for example, the user device 120-1. In S260, it is checked whether additional requests for video content are received from the user device 120 and if so, execution continues with S210; otherwise, execution terminates.

FIG. 3 depicts an exemplary and non-limiting flowchart describing the operation 230 of generating an animated gif file respective of a video content item according to an embodiment. In S230-10, the operation starts when at least one codec of the plurality of codecs 150 is selected. The selection of the codec is made respective of the type of the video content item, i.e, certain file formats may require different decoding and therefore different codecs. In S230-20, the at least one selected codec, for example the codec 150-1 is initialized by the server 130 to decode the video content item to a set of frames. In S230-30, the set of frames is encoded into an animated gif file and execution terminates.

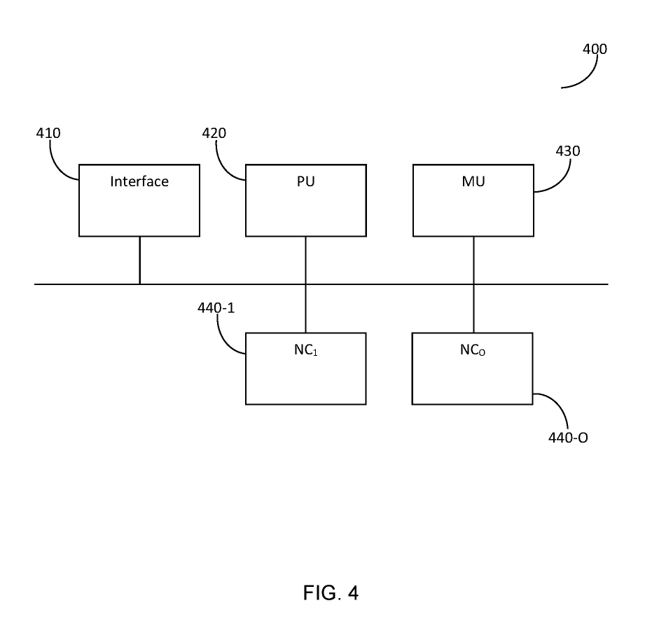

FIG. 4 depicts an exemplary and non-limiting schematic diagram of an agent 400 installed on the user device 120 to enable generating and sending of animated gif files respective of video content items according to an embodiment. The agent 400 comprises an interface 410. The interface 410 enables communication to the network. The interface 410 further enables sending and receipt of data and requests that are communicated to and from a user of the user device 120. The interface 410 further enables fetching the video content item and respective metadata when the video content item is requested to be sent from the mobile device 120 and its respective metadata.

The agent 400 further comprises a processing unit (PU) 420 configured to process the fetched video content item and its respective metadata and configured to identify the type of the video content item respective thereof. The agent further comprises a memory unit (MU) 430. The MU 430 contains therein instructions that when executed by the PU 420 configures the agent as further described hereinabove and below. The agent 400 further comprises one or more native codecs 440-1 through 440-O (collectively referred hereinafter as native codecs 440 or individually as a native codec 440, merely for simplicity purposes.

It should be noted that native in this respect does not refer to native code but rather to the codec script disclosed herein. The native codec 430 is configured to decode the fetched video content item to a set of frames.

The processing unit 320 is further configured to generate an animated gif file respective of the set of frames and send it as instructed by a user of the user device 120 via the interface 410 to another user device, for example, the user device 120-2 via the network 110.

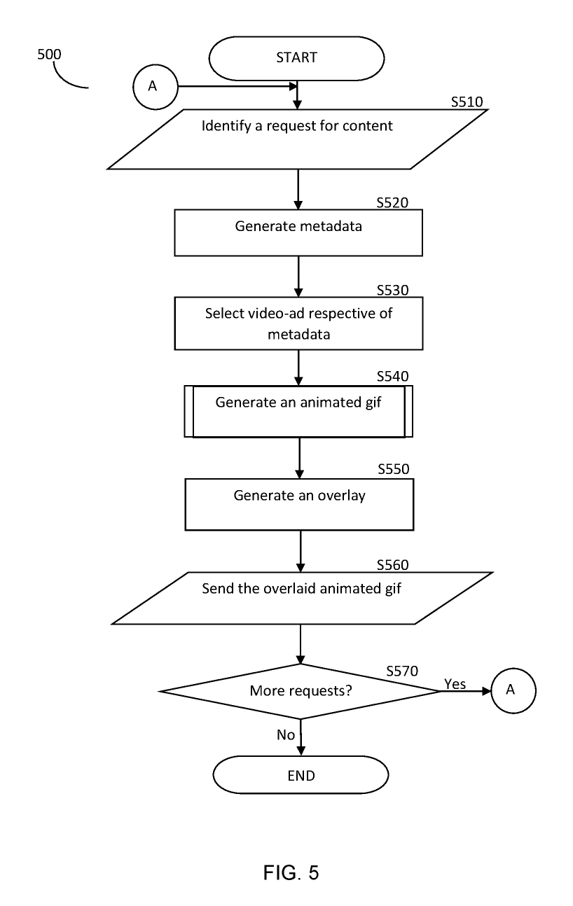

FIG. 5 depicts an exemplary and non-limiting flowchart 500 describing an operation of a video-ad system according to an embodiment. In S510, the operation starts when a request for content that exists in a web source, for example the web source 140-1, is received from a user device, for example, the user device 120-1 via the network 110. In S520, metadata respective of the content is generated by the server 130. The metadata may be generated by, for example, identifying the requested content, a type of the user device 120-1, a type of the request, i.e. a web source that led to the request, etc.

In S530, the server 130 selects at least one video-ad to be displayed on a display of the user device 120-1 respective of the metadata. According to an embodiment, the selection process may include querying of, for example, a publisher server.

In S540, the server 130 generates an animated gif file respective of the selected video-ad. The generation of the animated gif file is further described hereinabove with respect of FIG. 3.

In optional S550, an overlay comprising one or more features is generated respective of the metadata. The feature(s) may include a link to the web source 140-1 or other content over the network associated therewith.

In S560, the overlaid animated gif file is provided to the user device 120-1. In S570, it is checked whether additional requests for video content are received from the user device 120-1 and if so, execution continues with S510; otherwise, execution terminates. After the user device 120-1 receives the overlaid animated gif file, the user device 120-1 may embed the overlaid animated gif file into the email being composed.

The principles of the disclosure, wherever applicable, are implemented as hardware, firmware, software or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program embodied in non-transitory computer readable medium, or any combination thereof, which may be executed by a CPU, whether or not such computer or processor is explicitly shown. Implementations may further include full or partial implementation as a cloud-based solution. In some embodiments certain portions of a system may use mobile devices of a variety of kinds. In addition, various other peripheral units may be connected to the computer platform such as an additional data storage unit and a printing unit. The circuits described hereinabove may be implemented in a variety of manufacturing technologies well known in the industry including but not limited to integrated circuits (ICs) and discrete components that are mounted using surface mount technologies (SMT), and other technologies.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computerized method for dynamically generating animated gif files for delivery via a network, the method comprising:
receiving a request from a first user device to send at least one video content item via a delivery system to at least one source over the network;
fetching the at least one video content item and metadata respective thereof;
generating an animated gif file respective of the at least one video content item;
generating an overlay to the animated gif file respective of the metadata; and,
sending the animated gif file together with the overlay to the at least one source.

2. The computerized method of claim 1, wherein the overlay comprises a responsive link to the at least one video content item.

3. The computerized method of claim 1, wherein the user device is one of a group consisting of a smart phone, a mobile phone, a tablet computer, a wearable computing device, a personal computer, and a smart television.

4. The computerized method of claim 1, wherein the generation of the animated gif file further comprises:
selecting at least one codec respective of the metadata;
configuring the at least one codec to decode the at least one video content item to a set of frames; and,
generating the animated gif file respective of the set of frames.

5. The computerized method of claim 1, wherein the delivery system is an e-mail system.

6. The computerized method of claim 1, wherein (i) receiving the request, (ii) fetching the at least one video content item and metadata respective thereof, (iii) generating the animated gif file, (iv) generating the overlay, and (v) sending the animated gif file together with the overlay is performed by a computing system in response to a single user input gesture performed at the first user device without additional user input at the first user device.

7. The computerized method of claim 1, wherein the metadata includes at least one of a group consisting of a type of the at least one video content item, a length of the at least one video content item, a resolution of the at least one video content item, container data, video data, audio data, and textual data.

8. A non-transitory computer readable medium having stored thereon instructions for causing one or more processing units to execute operations comprising:
receiving a request from a first user device to send at least one video content item via a delivery system to at least one source over the network;
fetching the at least one video content item and metadata respective thereof;
generating an animated gif file respective of the at least one video content item;
generating an overlay to the animated gif file respective of the metadata; and,
sending the animated gif file together with the overlay to the at least one source.

9. A system for dynamically generating animated gif files for delivery via a network, the system comprises:
an interface to receive a request from a first user device to send at least one video content item via a delivery system to at least one source over the network;
a plurality of codecs;
a processing unit connected to the interface;
memory connected to the processing unit, the memory containing instructions therein that when executed by the processing unit configure the system to:
fetch the at least one video content item and metadata respective thereof;
generate an animated gif file respective of the at least one video content item;
generate an overlay to the animated gif file respective of the metadata; and,
send the animated gif file together with the overlay to the at least one source.

10. The system of claim 8, wherein the user device is one of a group consisting of a smart phone, a mobile phone, a tablet computer, a wearable computing device, a personal computer (PC), and a smart television.

11. The system of claim 8, wherein the overlay comprises a responsive link to the at least one video content item.

12. The system of claim 8, wherein the generation of the animated gif file further comprises:
selecting at least one codec respective of the metadata;
configuring the at least one codec to decode the at least one video content item to a set of frames; and,
generating the animated gif file respective of the set of frames.

13. The system of claim 8, wherein the delivery system is an e-mail system.

14. The system of claim 9, wherein (i) receiving the request, (ii) fetching the at least one video content item and metadata respective thereof, (iii) generating the animated gif file, (iv) generating the overlay, and (v) sending the animated gif file together with the overlay is performed by a computing system in response to a single user input gesture performed at the first user device without additional user input at the first user device.

15. The system of claim 8, wherein the metadata includes at least one of a group consisting of a type of the at least one video content item, a length of the at least one video content item, a resolution of the at least one video content item, container data, video data, audio data, and textual data.

16. The system of claim 8, wherein the at least one source is a second user device.

17. A computerized method for dynamically providing animated gif files as video advertisements, the method comprising:
receiving a request for content that exists in a web source from a user device over a network;
generating metadata respective of the request;
selecting at least one video advertisement respective of the metadata;
generating an animated gif file respective of each of the at least one selected video advertisement; and,
sending the animated gif file to the user device.

18. The computerized method of claim 15, further comprising:
generating an overlay to the animated gif file respective of the metadata; and, adding the overlay to the animated gif file.

19. The computerized method of claim 16, wherein the overlay comprises a responsive link to the at least one video content item.

20. The computerized method of claim 15, wherein the user device is one a group consisting of a smart phone, a mobile phone, a tablet computer, a wearable computing device, a personal computer, and a smart television.

21. The computerized method of claim 15, wherein the generation of the animated gif file further comprises:
selecting at least one codec respective of the metadata;
configuring the at least one codec to decode the at least one video content item to a set of frames; and,
generating an animated gif file respective of the set of frames.

22. The computerized method of claim 1, wherein the metadata comprises at least one of the group consisting of: a type of the video content item, a type of request, and a type of user device.

23. A non-transitory computer readable medium having stored thereon instructions for causing one or more processing units to execute operations comprising:
receiving a request for content exist in a web source from a user device over a network;
generating metadata respective of the request;
selecting at least one video-ad respective of the metadata;
generating an animated gif file respective of each of the at least one selected video-ad; and,
sending the animated gif file to the user device.
